(19) United States
(12) Patent Application Publication
(10) Pub. No.: US 2009/0185575 A1
(43) Pub. Date: Jul. 23, 2009

(54) PACKET SWITCH APPARATUS AND METHOD

(75) Inventors: Waki Iwata, Kawasaki (JP); Katsuya Tsushita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/274,690

(22) Filed: Nov. 20, 2008

(30) Foreign Application Priority Data
Jan. 21, 2008 (JP) 2008-010879

(51) Int. Cl. H04L 12/56

(52) U.S. Cl. 370/422

(57) ABSTRACT

A packet switch apparatus for switching a packet between a plurality of input ports and a plurality of output ports includes a plurality of input buffers for storing a packet inputted to the input port, a plurality of output buffers for storing a packet outputted to the output port, and a path controller for transmitting the packet stored in the input buffer to the output buffer on the basis of path information of the packet stored in the input buffer by a higher transfer rate than an input rate for receiving the packet at the input port.

### CROSS REFERENCE TO RELATED APPLICATIONS

This application is based upon and claims the benefit of priority from the prior Japanese Patent Application No. 2008-010879, filed on Jan. 21, 2008, the entire contents of which are incorporated herein by reference.

### BACKGROUND

The embodiments discussed herein are related to a packet switch apparatus and method for packet switching between a plurality of input ports and a plurality of output ports, and more particularly, to a packet switch apparatus and method for switching a transmission route on the basis of a path information included in a received packet.

Conventionally, Local Area Network (LAN) is connected to Wide Area Network (WAN), thereby using a packet switching apparatus (for instance, router apparatus) for enabling Internet communication between computers of a client/server model or data communication such as Intranet.

Further, a switch apparatus is used to control the switching operation by mixing communication such as packet communication with a variable rate to communication with a fixed rate, Japanese Laid-open Patent Publication No. 2000-333279 proposes such a switch apparatus.

Herein, a relay method of the packet switch (a transmission mode of a frame) is mainly classified into a store-and-forward method, a cut-through method, and a fragment-free method. With the store-and-forward method for receiving all of input packets, checking whether or not the packets are normal, and thereafter determining an output port, an FIFO memory is frequently used as an input buffer to store the input packet.

FIG. 16 shows the structure of a conventional packet switch apparatus. FIG. 17 shows the operation thereof. With the structure shown in FIG. 16, a packet inputted to an input port 111A is temporarily stored to a receiving FIFO unit 112A, and a packet inputted to an input port 111B is temporarily stored to a receiving FIFO unit 112B.

A path selecting unit 113C selects and reads a packet for being outputted from an output port 114C from among the packets stored in the receiving FIFO units 112A and 112B. A path selecting unit 113D selects and reads a packet for being outputted from an output port 114D from among the packets stored in the receiving FIFO units 112A and 112B. Thereby a path of the packet is controlled.

Herein, a bandwidth of the input ports 111A and 111B is 1 Gbps respectively, and a bandwidth of the output ports 114C and 114D is 1 Gbps respectively A description will be given of an operation upon concentrating the packets addressed to the output port 114C from the input ports 111A and 111B with reference to FIG. 17. Incidentally, reference numeral XYₙ of the packet denotes selection of a route from a port (X) to a port (Y).

Both the input ports 111A and 111B have the bandwidth of 1 Gbps. The packet is read by 1 Gbps from the receiving FIFO units 112A and 112B. An output bandwidth of the output port 114C is 1 Gbps, therefore, upon continuously inputting the packet addressed to the output port 114C from the receiving FIFO units 112A and 112B, the transmission quantity of the packets is over bandwidth of the output port 114C. In this case, the operation for reading the packet from the receiving FIFO unit 112A and 112B is interrupted.

In this case, the packet from the input port 111B to the output port 114D is influenced from the interruption of the reading operation, due to the situation of the output port 114C. Although the output port 114D fully has a capacity of the output bandwidth, the output port 114D cannot output the packet and expected performance thereof cannot be thus exhibited.

Further, when the bandwidth is over the standby limit of the receiving FIFO unit, not only the packet addressed to the output port 114C but the packet addressed to the output port 114D having another a capacity of the output bandwidth can be dropped.

With the conventional technology, in a packet switch for selecting paths for the packets received in a plurality of input ports to which receiving bands are prescribed and for transmitting the selected paths to the addressed output ports, the packets addressed to a specific output port are concentrated and an available bandwidth of the output port is close to the upper limit thereof. Then, the operation for reading the packet from the receiving FIFO is interrupted. Thus, there is a problem that the packet addressed to anther output port having a capacity of the bandwidth must wait at the receiving FIFO and expected performance thereof cannot be exhibited.

Further, depending on the depth (capacity) of the receiving FIFO and the degree of concentration to a specific output port, the receiving FIFO unit cannot absorb the packets. There is a problem such that, although there is a capacity of the output bandwidth, the receiving FIFO drops the packet.

### SUMMARY

According to an aspect of an embodiment, there is provided a packet switch apparatus for switching a packet between a plurality of input ports and a plurality of output ports, the packet switch apparatus includes a plurality of input buffers for storing a packet inputted to the input port, a plurality of output buffers for storing a packet outputted to the output port, and a path controller for transmitting the packet stored in the input buffer to the output buffer on the basis of path information of the packet stored in the input buffer by a higher transfer rate than an input rate for receiving the packet at the input port.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is an explanatory diagram of the basic function structure of a packet switch apparatus;

FIG. 2 is a diagram showing an example of the function structure in case of the packet switch apparatus having two input ports and two output ports;

FIG. 3 is an explanatory diagram of an operation of a packet switch apparatus shown in FIG. 2;

FIG. 4 is an explanatory diagram of a data format example used in the packet switch apparatus;

FIG. 5 is an explanatory diagram of the function structure of a receiving FIFO unit;

FIG. 6 is an explanatory diagram of packet storage in a receiving FIFO unit;

FIG. 7 is an explanatory diagram of the function structure of a packet selection requesting unit;

FIG. 8 is an explanatory diagram of the function structure of a transmitting FIFO unit;

FIG. 9 is an explanatory diagram of packet storage in a transmitting FIFO unit;

FIG. 10 is an explanatory diagram of the structure of the packet switch apparatus upon receiving a data stop request from the output port;

FIG. 11 is a diagram showing the function structure of a transmitting FIFO unit;

FIG. 12 is a diagram showing an example of the packet switch apparatus for distributing packet inputted from one input port and a test packet generated by a test packet generating unit in the packet switch apparatus into two output ports;

FIG. 13 is a diagram showing the function structure of a test packet generating unit;

FIG. 14 is a diagram showing an example of the structure of the packet switch apparatus that distributes the packet inputted from two input ports into one output port and a packet terminal portion;

FIG. 15 is a diagram showing an example of the function structure in case of the packet switch apparatus having three input ports and three output ports;

FIG. 16 is an explanatory diagram of the structure of a conventional packet switch apparatus; and

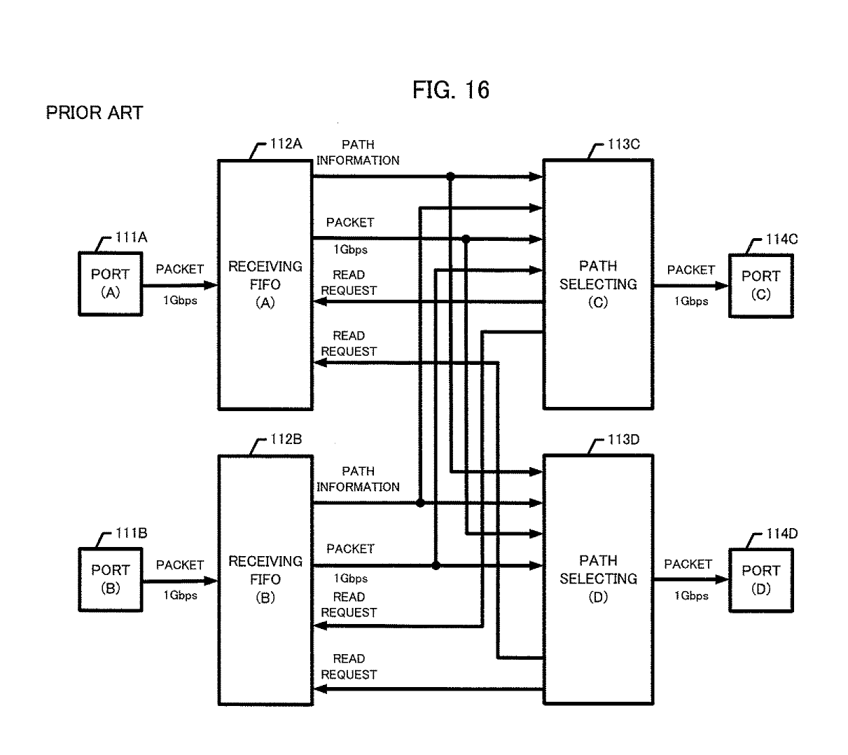

FIG. 17 is an explanatory diagram of an operation of a conventional packet switch apparatus.

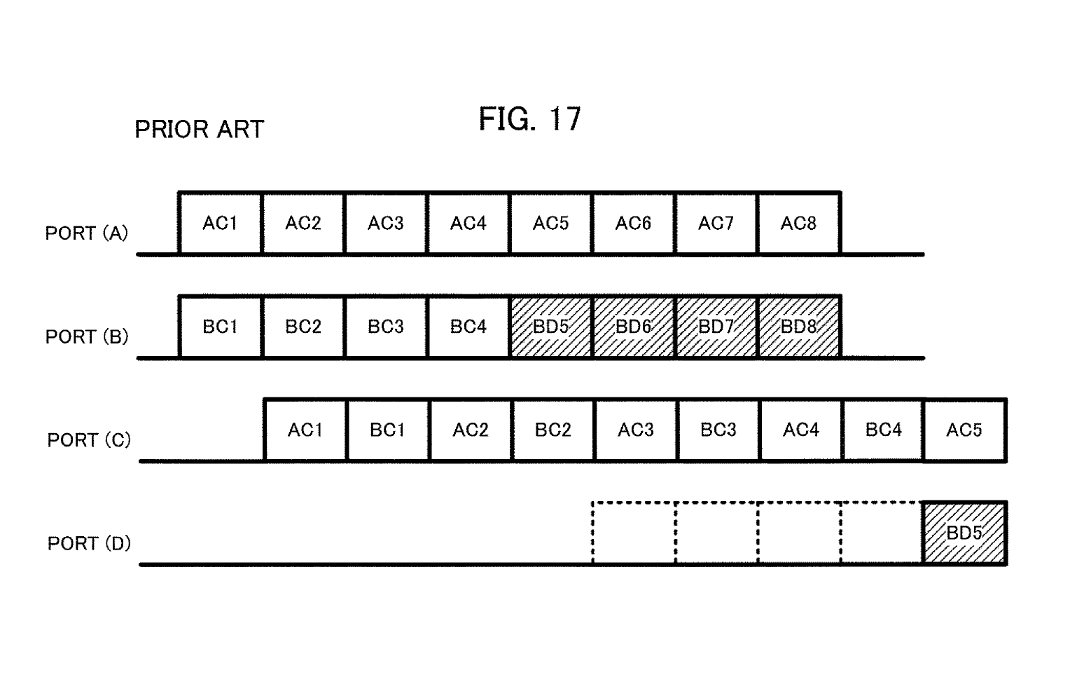

### DESCRIPTION OF THE PREFERRED EMBODIMENTS

Hereinbelow, a specific description will be given of a packet switch apparatus and a packet switch method according to embodiments with reference to the drawings.

### First Embodiment

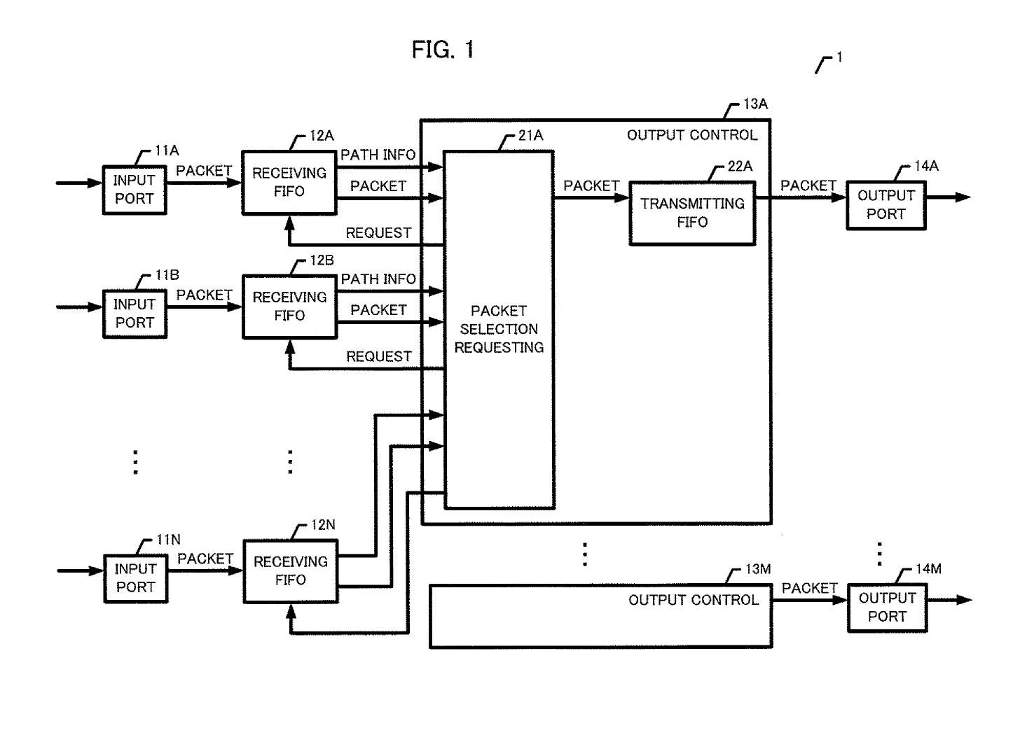

FIG. 1 is an explanatory diagram of the basic function structure of the packet switch apparatus according to the embodiment. A packet switch apparatus 1 shown in FIG. 1 is a packet switch for N-to-M switching, and includes N input ports 11A to 11N and M output ports 14A to 14M.

Receiving FIFO units 12A to 12N are arranged to the back stages of the input ports 11A to 11N and are used as standby buffers for dropping an error packet and for switching a route. Further, output control units 13A to 13M arranged to the front stages of the output port 14A to 14M have therein packet selection requesting units 21A to 21M and transmitting FIFO units 22A to 22M.

The packet selection requesting units 21A to 21M are path control units for controlling the reception and transmission of the packets from the receiving FIFO units 12A to 12N to the transmitting FIFO unit 22A to 22M on the basis of address information (path information) of the packets stored in the receiving FIFO units 12A to 12N. The transmitting FIFO units 22A to 22M are output buffers used for the standby situation for adjusting the output rate, and the packets are temporarily stored in the buffers and are thereafter outputted from the output ports 14A to 14M.

Further, in the packet switch apparatus 1, a transfer rate of the packet from the receiving FIFO units 12A to 12N to the transmitting FIFO units 22A to 22M is higher than an input rate for receiving the packets by the input port 11A to 11N. As a consequence, if the packets are concentrated to a specific output port, the entire operational efficiency is improved by preventing the data delay due to the reduction in operational efficiency at another output port and the drop of the packet.

Preferably, the transfer rate between the receiving FIFO unit and the transmitting FIFO unit is equal to or higher than the total values of input rates of all input ports. In the packet switch apparatus 1 shown in FIG. 1, N input ports have the same input rate and a transfer rate higher than the input rate by N times.

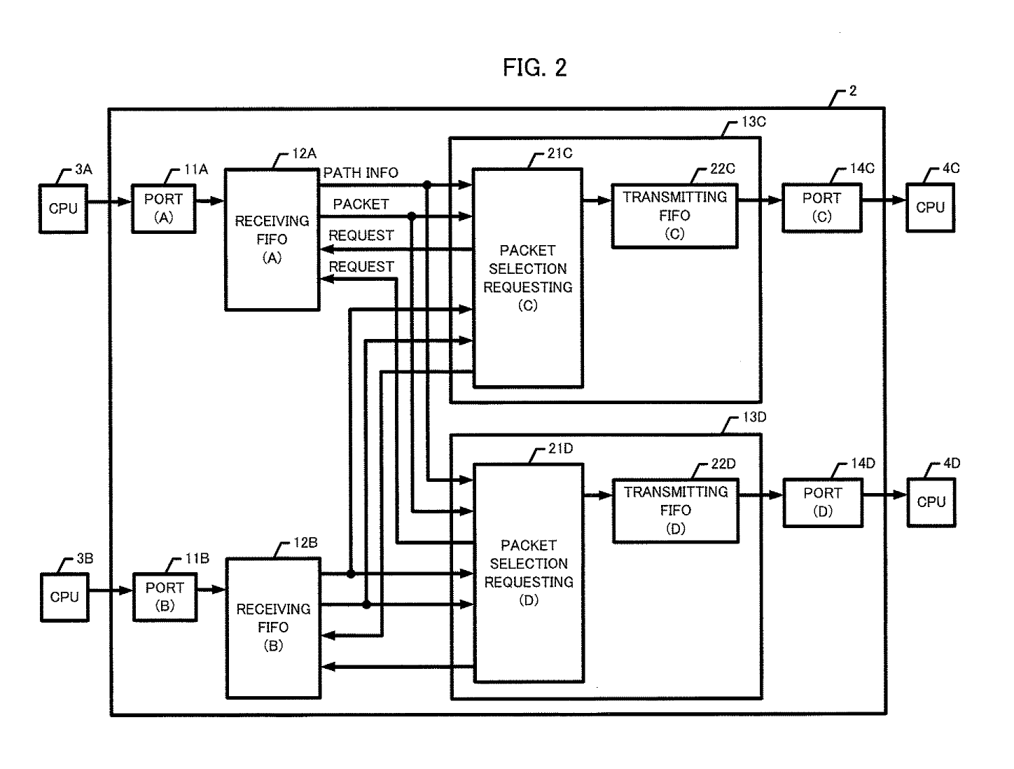

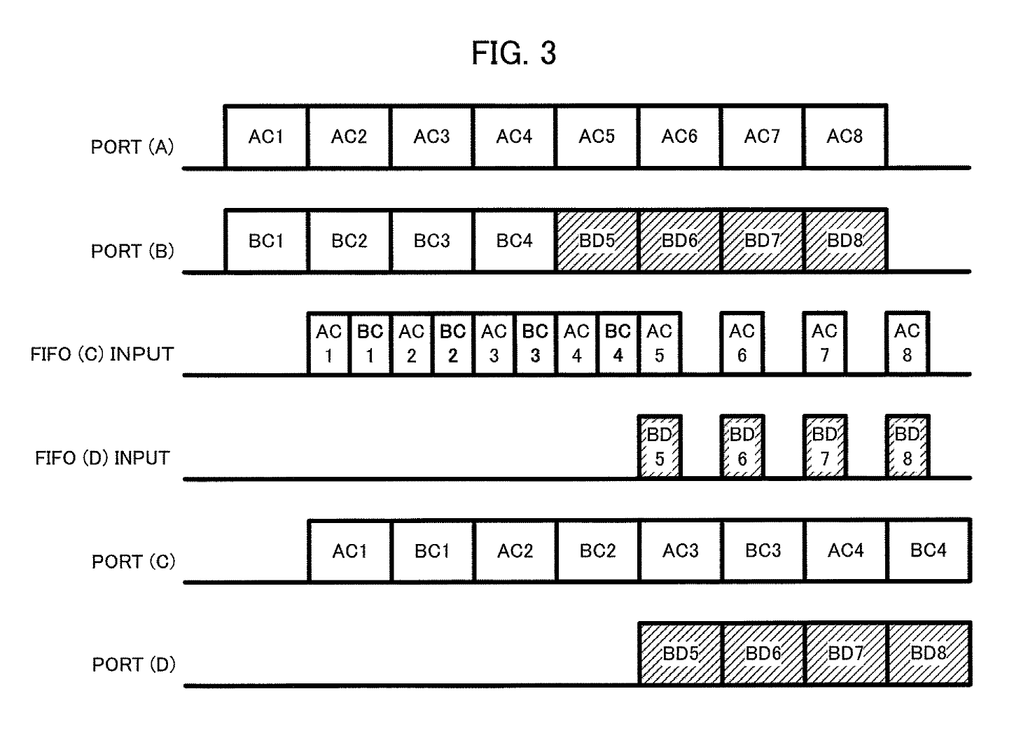

Subsequently, a description will be given of an operation of a (2×2) packet switch apparatus for distributing the packet inputted from two input ports into two output ports. FIG. 2 is a diagram showing the function structure (structure example of 2×2) and FIG. 3 is a diagram showing the operation thereof.

With the structure shown in FIG. 2, a packet switch apparatus 2 includes two input ports 11A and 11B and output ports 14C and 14D. The input port 11A receives the packet from a CPU (Central Processing Unit) 3A as an external-device terminal, and the input port 11B receives the packet from a CPU 3B as an external-device terminal. Further, the output port 11C transmits the packet to a CPU 4C as an external-device terminal, and the output port 11D transmits the packet to a CPU 4D as an external-device terminal.

The input rates of the input ports 11A and 11B are individually 1 Gbps, and the output rates of the output port 14C and 14D are individually 1 Gbps. The packet is read from the receiving FIFO units 12A and 12B by 2 Gbps higher than the input rates (receiving bandwidths) of the output ports 11A and 11B. Further, the transmitting FIFO units 22C and 22D are arranged to the back stage of the packet selection requesting units 21C and 21D on the unit basis of output port respectively, and the packet drop point is changed from the receiving FIFO to the transmitting FIFO.

FIG. 3 is an explanatory diagram of an operation for reading the packet at a clock rate as the twice of a rate of an input clock, with the reading operation of 2Gbps. In the operation example shown in FIG. 3, the packets addressed to the output port 14C (PORT(C)) are concentrated to the input port 11A (PORT(A)), and the packet addressed to the output port 14C and the packet addressed to the output port 14D (PORT(D)) are mixed at the input port 11B (PORT(B)). Incidentally, reference numeral XYₙ of the packet denotes selection of a route from a port (X) to a port (Y).

However, the packet is read from the receiving FIFO units 12A and 12B at the clock rate as the twice of the rate of the input clock and is stored to the transmitting FIFO units 14C and 14D. Therefore, if the packets are concentrated to the output port 14C, the packet transmission from the output port 14D is not delayed.

In addition to the increase in clock rate, the number of parallel data is increased, thereby raising the transfer rate between the transmitting/receiving FIFOs.

A description will be given of a specific operation of the packet switch apparatus 2. First of all, the packets inputted in the input port 11A and the input port 11B are stored to the receiving FIFO units 12A and 12B. The receiving FIFO unit for storing one or more packet sends a notification indicating path information of the packet (packet first-received in the FIFO) to be next transmitted to the packet selection requesting units 21C and 21D. The path information indicates that there is the packet to be transmitted in the receiving FIFO and whether the packet is addressed to the output port 14C or the output port 14D.

The packet selection requesting units 21C and 21D refer to path information of both the receiving FIFO units 12A and 12B, select the receiving FIFO units that transmits the path information addressed thereto, and transmit a packet request to the selected receiving FIFO. When both the path information from the receiving FIFO units 12A and 12B is addressed to the same path, the packet is requested only to one of the receiving FIFO units 12A and 12B by using round-robin or another selecting algorithm.

The receiving FIFO units that receive the packet request transmit the packet to both the packet selection requesting units 21C and 21D. In this case, the rate for transmitting the packet is twice of the receiving rate of the receiving FIFO unit.

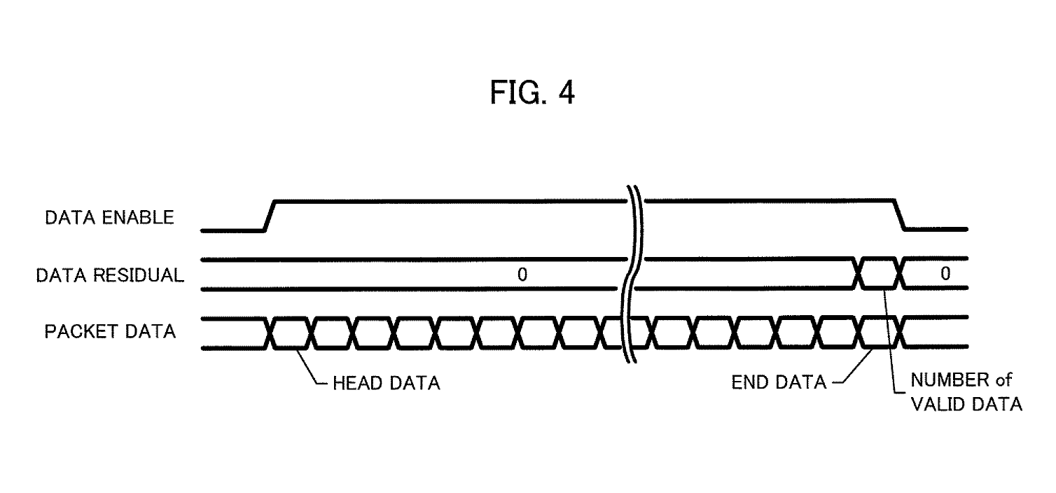

FIG. 4 is an explanatory diagram of a data format example used in the packet switch apparatus. The packet data is serial or parallel bit data transmitted together with data enable indicating a valid term of data. If the data is parallel bit, a data residual signal indicating the number of valid data, less than the number of parallel bits, can be given to the end of the packet. The packet data means data that composes the packet.

The packet selection requesting units 21C and 21D select the packet from the receiving FIFO unit on the packet request side, and transmits the packet to the transmitting FIFO units 22C and 22D by the same rate (as twice of the receiving rate of the receiving FIFO unit). The receiving FIFO units 12A and 12B transmit the same packet to both the packet selection requesting units 21C and 21D. Therefore, the packet from the receiving FIFO unit on the side on which the packet is not requested is not selected.

The transmitting FIFO units 22C and 22D store the packet received from the packet request selecting units 21C and 21D, and transmit the packet to the output ports 14C and 14D. In this case, the transmitting rate to the output port is arbitrary and is prescribed by the CPU 4C and the CPU 4D.

If transmitting the packet over the capacity of the transmitting FIFO units 22C and 22D from the packet selection requesting units 21C and 21D, the packet is dropped on the writing side of the transmitting FIFO units 21C and 21D.

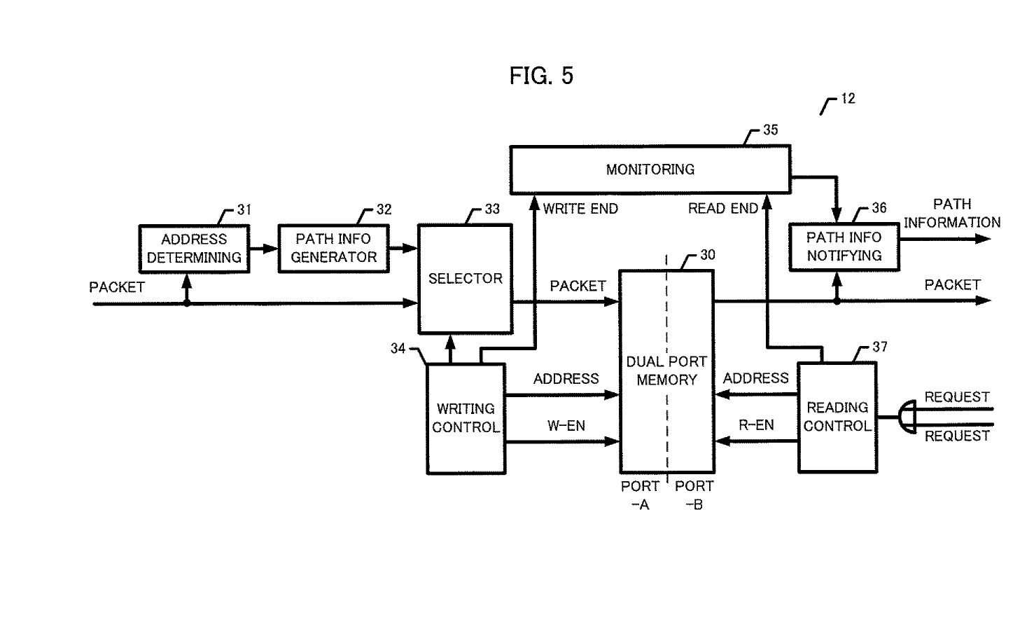

Next, a description will be given of the function structure of the receiving FIFO unit with reference to FIG. 5. The receiving FIFO unit 12 shown in FIG. 5 includes a RAM 30 with the Dual-Port structure, the data-widths and the clock rates individually have different values between a writing port and a reading port of the RAM 30 (the reading rate is higher than the writing rate by any of two methods including a method for increasing the number of parallel reading data and a method for increasing the reading clock rate or both of the two methods).

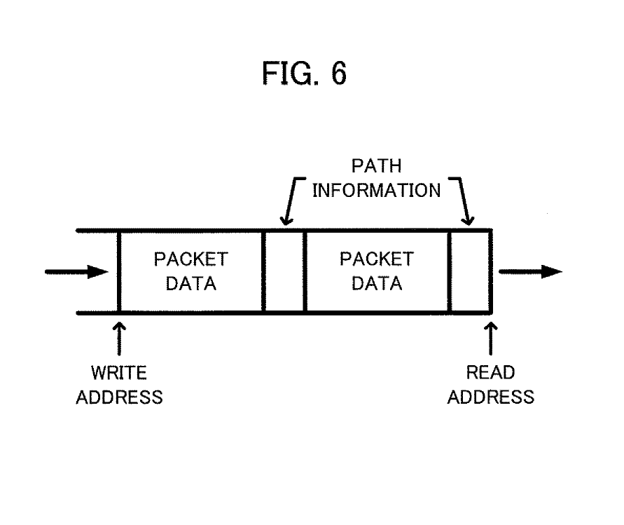

FIG. 6 is an explanatory diagram of packet storage in the receiving FIFO unit 12. Referring to FIG. 6, the receiving FIFO stores the path information as well as the packet data.

A writing control unit 34 in FIG. 5 has a function for managing an address to which the received data is written and Write Enable to the RAM 40 and storing the head address of the packet in progress of writing operation. Further, upon ending the writing operation of data corresponding to one packet, the writing control unit 34 in FIG. 5 sends a notification of the end to a monitoring unit 35 monitoring the number of packets in the FIFO.

The address determining unit 31 determines the address by referring to the packet. The address is added to the head of the packet as path information, and the packet added the address is written to the receiving FIFO. Since the determination of path ends after receiving the head data of the packet, an area for storing the path information is set in advance before storing the head data of the packet. After ending the determination of path, the path information is written to the set area.

The monitoring unit 35 monitoring the number of packets in the FIFO determines from information on the writing end and the reading end whether or not there is a readable packet in the FIFO. In figures, “information” is abbreviated, saying that “info”. When it is determined that there is a readable packet, this determined result is notified to a path information notifying unit 36.

The path information notifying unit 36 transmits a message indicating there is a transmittable data together with the path information stored to the head of the FIFO.

A reading control unit 37 controls a reading address. If receiving a transmitting request (request, in FIG. 5), the reading control unit 37 controls a reading operation of packet data corresponding to one packet. If ending the reading operation, the reading control unit 37 sends a notification indicating the end to the monitoring unit 35 monitoring the number of packets in the FIFO.

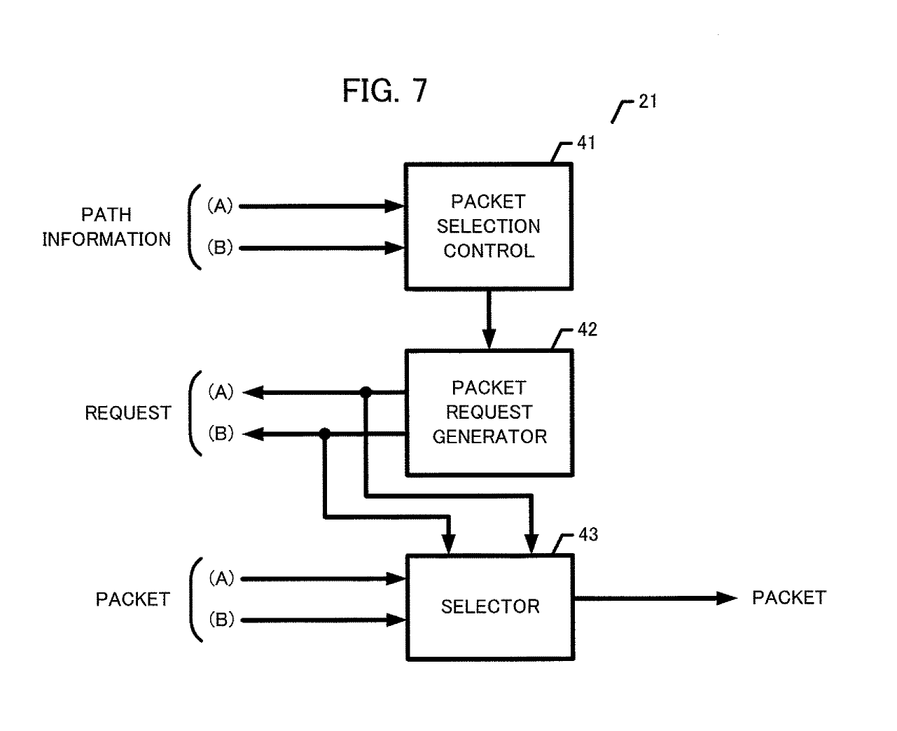

Next, a description will be given of the circuit structure of the packet selection requesting unit with reference to FIG. 7. As shown in FIG. 7, the packet selection requesting unit 21 includes a packet selection control unit 41, a packet request generator unit 42, and a selector 43.

The packet selection control unit 41 selects the receiving FIFO that can transmit the packet to the path thereof by referring to the received path information, and sends a notification indicating the selected receiving FIFO to the packet request generator unit 42 and the selector 43. The packet request generator unit 42 requests the packet to the receiving FIFO.

The selector 43 passes only packet inputted from the packet requesting side through the transmitting FIFO side. Incidentally, the packet selection requesting unit 21 is operated on the unit basis of the packet, does not request a new packet during receiving one packet, and also does not switch the selector.

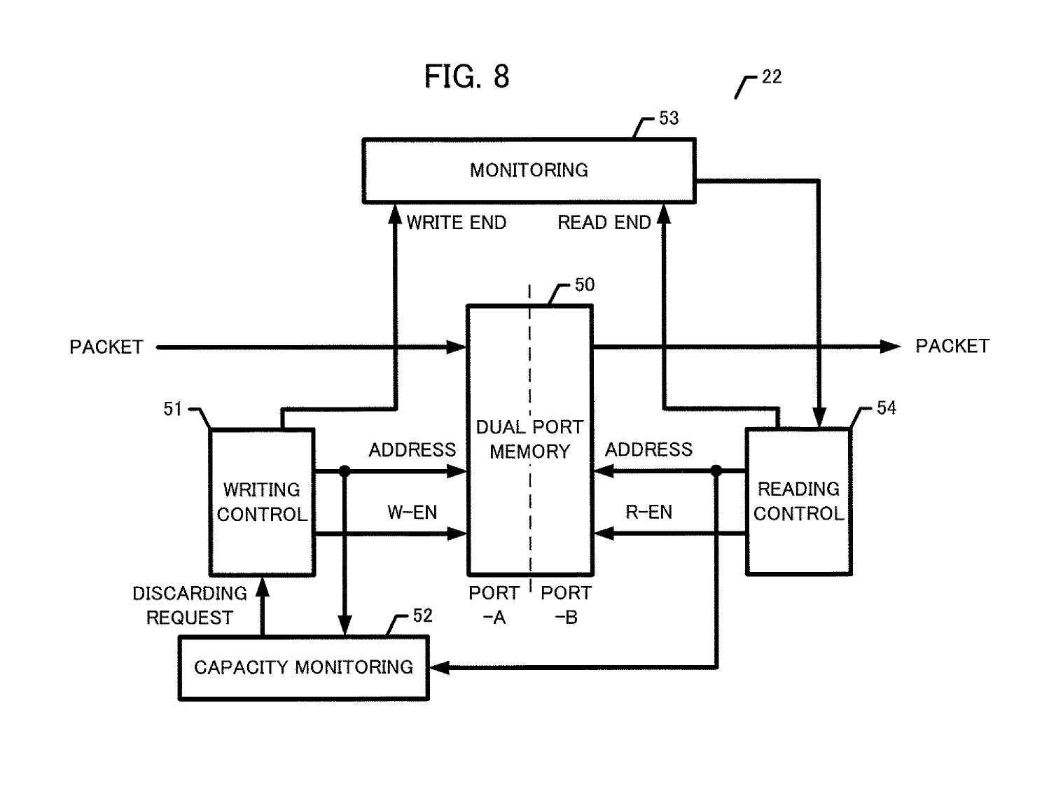

Next, a description will be given of the function structure of the transmitting FIFO unit with reference to FIG. 8. The transmitting FIFO unit 22 shown in FIG. 8 includes a RAM 50 with the Dual-Port structure, a data-width at the writing port and the reading port in the RAM 50 and a clock rate have different values (reading operation is realized with the data width and clock rate necessary for the transmitting port, irrespective of the writing rate).

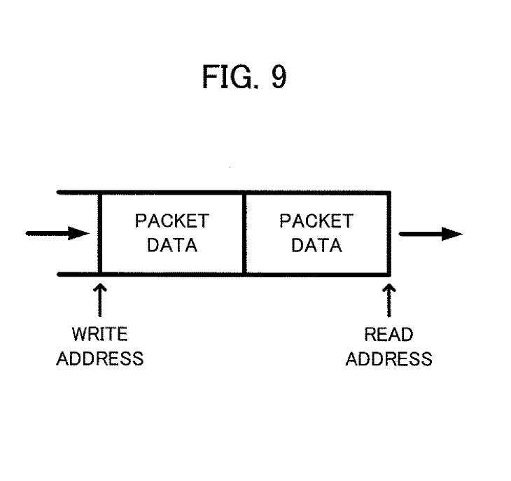

FIG. 9 is an explanatory diagram of the packet storage in the transmitting FIFO unit 22. As shown in FIG. 9, the transmitting FIFO does not store path information but stores only packet transmitted to the output port 14.

Referring to FIG. 8, a writing control unit 51 has a function for managing an address to which the received data is written and Write Enable to the RAM 50 and storing the head address of the packet in progress of being written. After ending the writing operation of data corresponding to one packet, this ending notification is notified to a monitoring unit 53 monitoring the number of packets in the FIFO.

The monitoring unit 53 determines from information on the writing end and the reading end whether or not there is a packet readable in the FIFO. When it is determined that there is a readable packet, this determined result is notified to a path information notifying unit 54.

A reading control unit 54 controls a reading address and also controls a reading operation on the unit basis of the packet. If ending the reading operation, the reading control unit 54 sends a notification indicating the end to the monitoring unit 53.

A capacity monitoring unit 52 monitors a writing address and a reading address. If the writing address is close to the reading address, the FIFO is set as full and a request for dropping the packet in progress of being written is issued.

Upon dropping the packet, Write Enable operation in the RAM 50 is performed up to the end of the packet in progress of being written by the writing control unit 51, and the writing address is returned up to the head of the packet in progress of being written.

In the operation of the 2×2 packet switch apparatus 2 as mentioned above, the reading rate of the receiving FIFO is twice of the writing rate, thereby setting the writing rate to the transmitting FIFO to double. Since the writing rate to the transmitting FIFO is equal to the total data receiving rates of the input ports 11A and 11B, it is not generated that the packet blocks it each other and the packet does not remain in the receiving FIFO. With the structure, when the packets over the bandwidth of the output port are concentrated to one port, the packet drops on the writing side of the transmitting FIFO unit.

### Second Embodiment

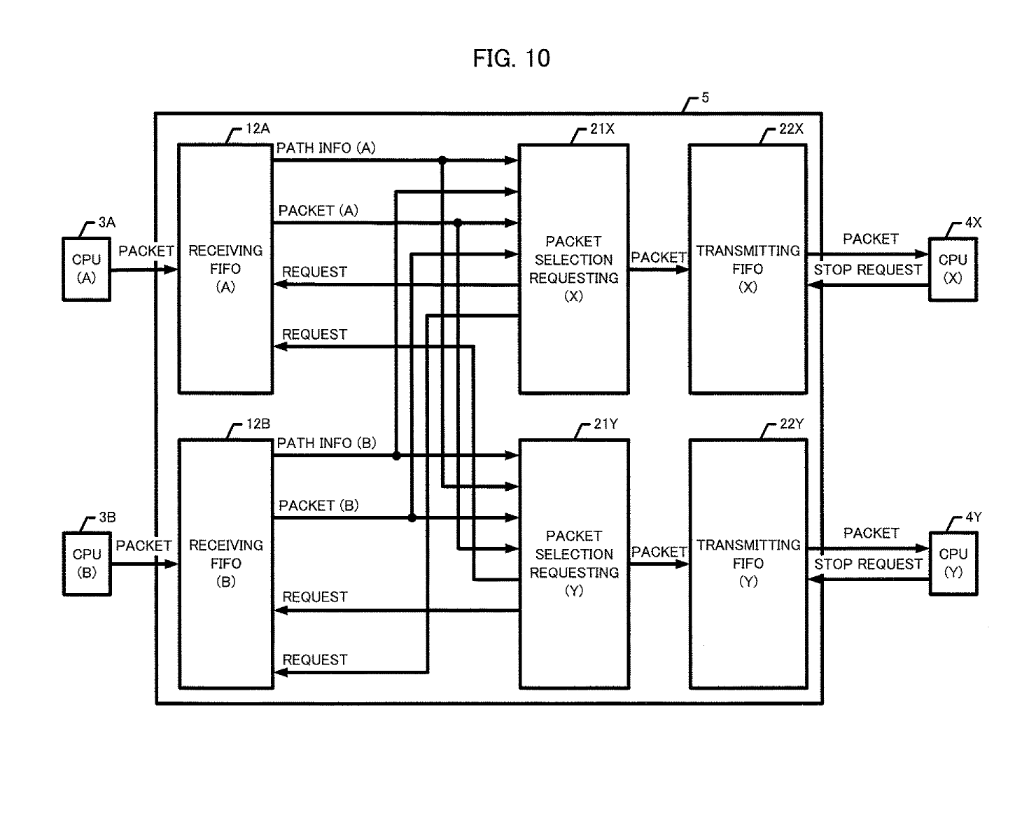

Next, a description will be given of a modification of the first embodiment. FIG. 10 is an explanatory diagram of the structure of a packet switch apparatus upon receiving a data stop request from the output port side. A packet switch apparatus 5 shown in FIG. 10 performs the same operation as that of the packet switch apparatus 2 shown in FIG. 2, except for inputting the data stop request from the CPUs 4X and 4Y to the transmitting FIFO units 22X and 22Y.

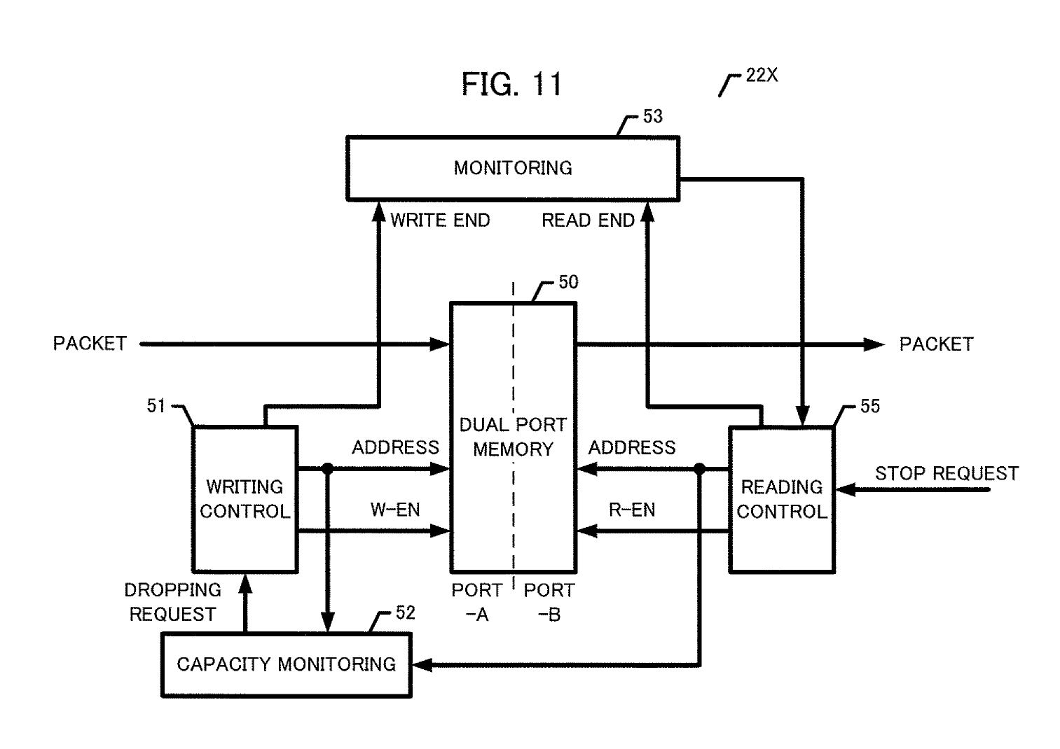

FIG. 11 is a diagram showing the function structure of the transmitting FIFO units 22X and 22Y. The transmitting FIFO units 22X and 22Y shown in FIG. 11 includes the RAM 50 with the Dual-Port structure, and the data-widths and clock rates are different between a writing port and a reading port in the RAM 50 (reading operation is realized by the data width and clock rate necessary for the transmitting port, irrespective of the writing rate).

The packet storage in the transmitting FIFO in FIG. 11 is similar to that shown in FIG. 8. Further, the writing control unit 51 has a function for managing an address to which the received data is written and Write Enable to the RAM 50 and storing the head address of the packet in progress of the writing operation. Further, upon ending the writing operation of data corresponding to one packet, the writing control unit 51 in FIG. 11 sends a notification of the end to a monitoring unit 53 monitoring the number of packets in the FIFO.

The monitoring unit 53 determines from information on the writing end and the reading end whether or not there is a packet readable in the FIFO. When it is determined that there is a readable packet, this determined result is notified to a path information notifying unit 55.

A reading control unit 55 controls a reading address. Only when the data stop request is not received, the reading control unit 55 controls a reading operation on the unit basis of the packet. After ending the reading operation, the reading control unit 55 issues a message indicating the end to the monitoring unit 53. The capacity monitoring unit 52 monitors a writing address and a reading address. If the writing address is close to the reading address, the FIFO is set as full and a request for dropping the packet in progress of being written is issued.

Upon dropping the packet, Write Enable operation in the RAM 50 is performed up to the end of the packet in progress of being written by the writing control unit 51, and the writing address is returned up to the head of the packet in progress of being written.

With the structure, the reading operation of the receiving FIFO does not stop, irrespective of the data writing operation to the transmitting FIFO in other words, when the data is not written to the transmitting FIFO, the transmitting FIFO unit receives the packet from the receiving FIFO and further drops the packet. Therefore, it is not generated that the packet blocks it each other and the packet does not remain in the receiving FIFO. With the structure, when the packets over the bandwidth of the output port are concentrated to one port, the packet drops on the writing side of the transmitting FIFO unit.

### Third Embodiment

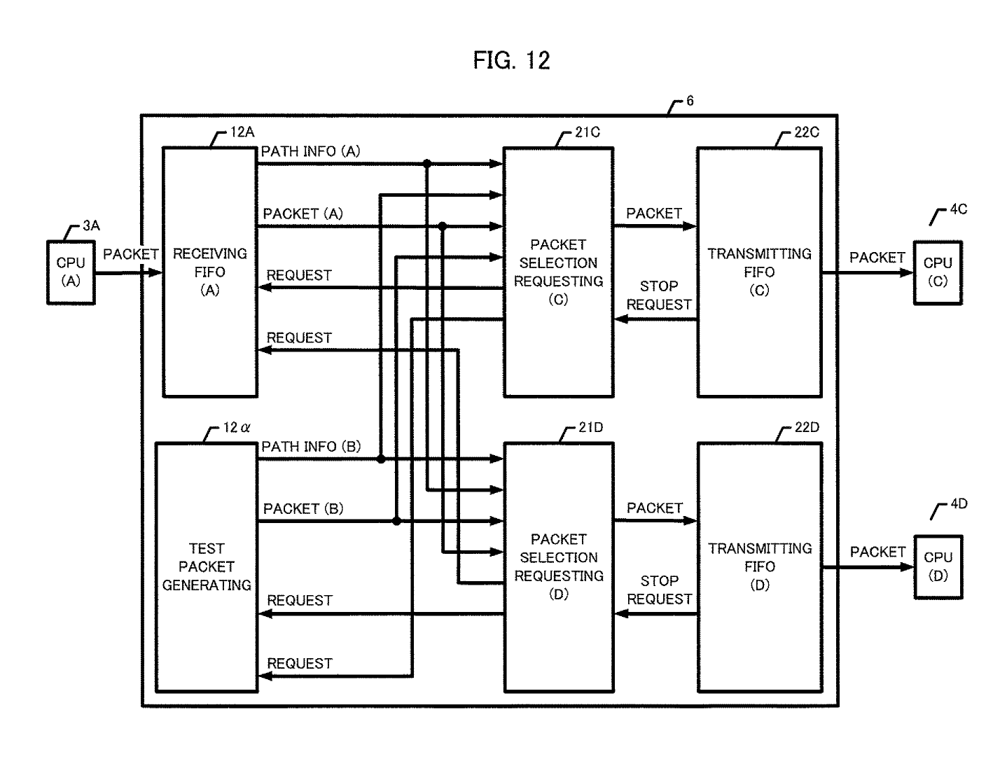

Further, according to the modification of the embodiments, a function for generating a test packet may be added to the function for externally receiving an input of the packet. FIG. 12 shows an example of the structure of a packet switch that distributes packet inputted from one input port and a test packet generated by a test packet generating unit in the packet switch into two output ports.

A packet switch apparatus 6 shown in FIG. 12 has the same structure and operation as those of the packet switch apparatus 2 shown in FIG. 2, except for distributing the test packet generated by a test packet generating unit 12α, as a distributing target, instead of the packet inputted from one input port.

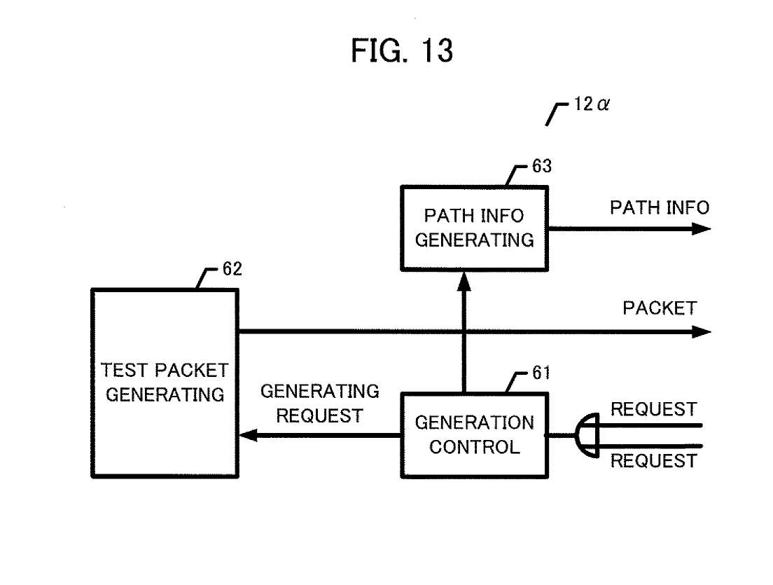

FIG. 13 shows the function structure of the test packet generating unit 12α. As shown in FIG. 13, the test packet generating unit 12α includes a generation control unit 61, a test packet generating unit 62, and a path information generating unit 63.

The generation control unit 61 determines a generating timing of the test packet and a transmitting path thereof in accordance with predetermined setting, and sends a notification indicating the generating timing and the transmitting path to the path information generating unit 63. Further, upon receiving a generating request (request, in FIG. 13), the generation control unit 61 transmits the generating request to the test packet generating unit 62.

The path information generating unit 63 transmits a fact that there is transmittable data at the generating timing of the test packet together with the path information. The test packet generating unit 62 generates the test packet and transmits the test packet upon receiving the generating request.

### Fourth Embodiment

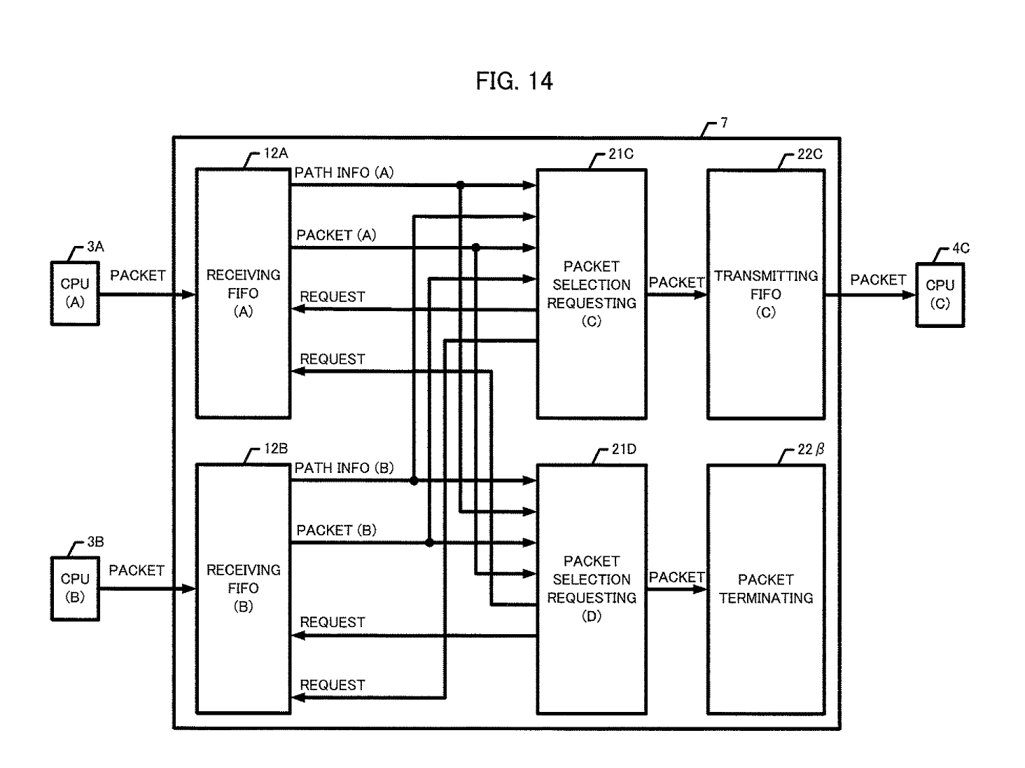

Further, according to the modification of the embodiments, a part of the packet may be terminated. FIG. 14 shows an example of the structure of the packet switch apparatus for distributing packet data inputted from two input ports into one output port and a packet terminal portion.

A packet switch apparatus 7 shown in FIG. 14 has the same structure and operation as those of the packet switch apparatus 2 shown in FIG. 2, except for setting a packet terminating unit 22β for terminating the packet in the packet switch, as the distributing address, instead of the output port.

### Fifth Embodiment

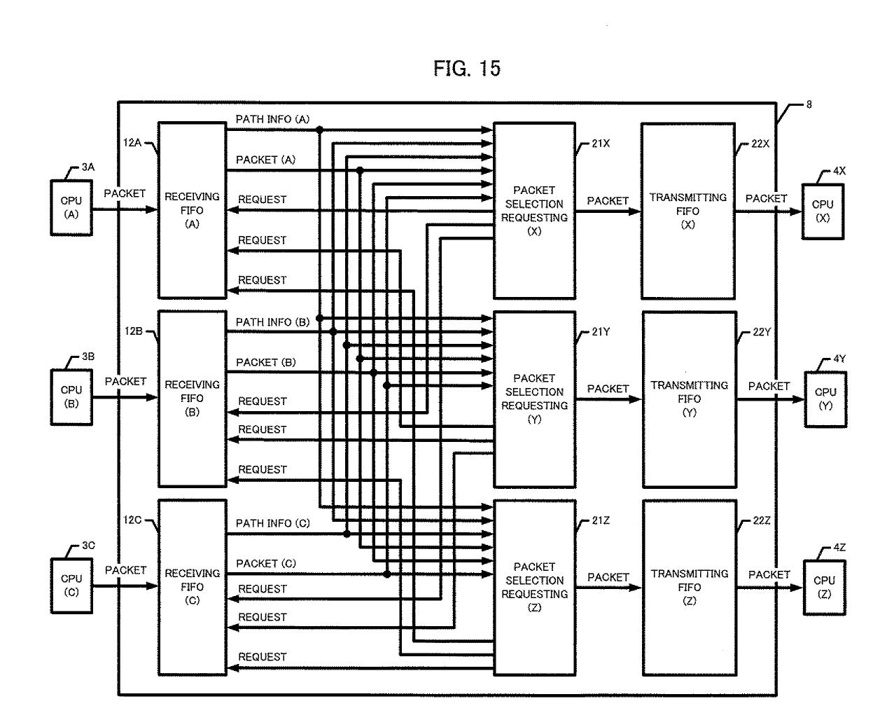

Further, as shown in FIG. 15, a (3×3) packet switch apparatus can be structured. A packet switch apparatus 8 shown in FIG. 15 distributes packet data inputted from three input ports into three output ports via receiving FIFO units 12A, 12B, and 12C, three packet selection requesting unit 21X, 21Y, and 21Z, and three transmitting FIFO units 22X, 22Y, and 22Z.

The packet switch apparatus 8 sets the reading rate of the receiving FIFO to three times of the writing rate, thereby setting the writing rate to the transmitting FIFOs to three times. Since the reading rate of the receiving FIFO is equal to the total data receiving rate from receiving ports (A), (B) and (C) (not showing in FIG. 15), Therefore, it is not generated that the packet blocks it each other and the packet does not remain in the receiving FIFO As mentioned above, with the packet switch apparatus according to the embodiments, since the reading operation for reading the packet data from the receiving FIFO is performed at the rate higher than the receiving bandwidth of the input port, the waiting at the receiving FIFO is not needed. Further, it is possible to solve the data delay (time loss) due to the band state of a specific output port.

Further, the drop point is the transmitting FIFO, thereby it is dropped only the packet over the transmitting bandwidth to a target port. Therefore, the drop of the packet addressed to the output port having another capacity in the bandwidth is solved.

As mentioned above, the embodiments are advantageous for a packet switch apparatus for packet switching between a plurality of input/output ports and, particularly, is suitable to improve the operational efficiency of the packet switch.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet switch apparatus for switching a packet between a plurality of input ports and a plurality of output ports, the packet switch apparatus comprising:
a plurality of input buffers for storing a packet inputted to the input port;
a plurality of output buffers for storing a packet outputted to the output port; and
a path controller for transmitting the packet stored in the input buffer to the output buffer on the basis of path information of the packet stored in the input buffer by a higher transfer rate than an input rate for receiving the packet at the input port.

2. The packet switch apparatus according to the claim 1, wherein the transfer rate is equal to or higher than the total input rate of all the input ports.

3. The packet switch apparatus according to the claim 1, wherein the path controller transmits the packet stored in the input buffer to the output buffer on the basis of the path information of the packet stored in the input buffer by a higher clock rate than an input clock rate for receiving the packet at the input point.

4. The packet switch apparatus according to the claim 1, wherein the path controller transmits the packet stored in the input buffer to the output buffer on the basis of the path information of the packet stored in the input buffer by a greater parallel number than a parallel number of the packet stored in the input buffer.

5. A packet switch method of a packet switch apparatus for switching a packet between a plurality of input ports and a plurality of output ports, the packet switch method comprising:
an input buffer step of storing a packet inputted to the input port in an input buffer;
a path control step of transmitting the packet stored in the input buffer to an output buffer on the basis of path information of the packet stored in the input buffer by a higher transfer rate than an input rate for receiving the packet at the input port; and
an output buffer step of storing a packet outputted to the output port in the output buffer.

6. The packet switch method according to the claim 5, wherein the transfer rate is equal to or higher than the total input rate of all the input ports.

7. The packet switch method according to the claim 5, wherein the path control step transmits the packet stored in the input buffer to the output buffer on the basis of the path information of the packet stored in the input buffer by a higher clock rate than an input clock rate for receiving the packet at the input point.

8. The packet switch method according to the claim 5, wherein the path control step transmits the packet stored in the input buffer to the output buffer on the basis of the path information of the packet stored in the input buffer by a greater parallel number than a parallel number of the packet stored in the input buffer.
